(19) United States
(12) Patent Application Publication
(10) Pub. No.: US 2006/0110639 A1
(43) Pub. Date: May 25, 2006

(54) Fuel cell with a regulated output

(75) Inventor: Markus Walter, Dettingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimierChrysler AG, Stuttgart (DE)

(21) Appl. No.: 10/525,450

(22) PCT Filed: Aug. 26, 2003
(86) PCT No.: PCT/DE03/02844

§ 371 Date: Sep. 1, 2005

(51) Int. Cl. H01M 8/04

(52) U.S. Cl. 429/22; 429/23

(57) ABSTRACT

The invention relates to a fuel cell system comprising at least one fuel cell (4), an electric intermediate accumulator (7), which is connected to common supply terminals (8) for an electric consumer (9), at least one sensor (10) for detecting an operating parameter of the fuel cell(s), a switch (6) for electrically connecting and/or disconnecting the fuel cell (4) to and from the intermediate accumulator (7) and the supply terminals (8), in addition to a control circuit (11) for opening and closing the switch (6) in accordance with the detected operating parameter.

A fuel cell is a device for the direct conversion of chemical energy into electrical energy which—unlike a battery—has to be continuously supplied with energy carriers in the form of fuel and oxidizing agent. The fuel for conventional low-temperature fuel cells is hydrogen, although other high-temperature fuel cells which convert carbon monoxide, methane or natural gas at a working temperature of approx. 1000° C. are also known.

Fuel cells used for stationary applications can be used in combination with pressurized stores for fuel and oxidizing agent which can supply gas streams which can be varied very quickly depending on the desired electrical output power of the fuel cell.

It is not suitable to use pressurized stores for fuel cells in mobile use, for example as an energy source for electric vehicles, on the one hand on account of their high mass which has to be moved with the vehicles and on the other hand on account of the potential danger presented by a pressurized store filled with fuel, in particular hydrogen, in the event of the vehicle having an accident.

Therefore, systems which use what is known as a reformer, which converts an energy carrier which cannot be directly exploited by the fuel cell but can be successfully transported for this purpose, e.g. gasoline, into a useable energy carrier, in practice a gas mixture substantially comprising H2, CO2 and steam, are preferred for the mobile use of fuel cells. One drawback of the reformers compared to pressurized stores is that the flow of fuel which they deliver can only be varied slowly, typically with a time constant of the order of magnitude of 100 s, whereas the volumetric flow from a pressurized store can be regulated with a time constant of no more than 0.01 S.

Since, in operation, the fuel cell always contains a certain quantity of fuel, it is for a brief time possible to extract more electric power than the amount which corresponds to the quantity of fuel supplied, but this leads to undesirable shifts in the chemical conditions in the fuel cell. In conventional fuel cell systems, this can only be avoided by setting the flow of fuel provided by the reformer to be greater than the current which is normally collected from the fuel cell, so that a fuel reserve is available in the event of a sudden increase in demand for electric power. However, since this additional fuel cannot be stored for subsequent use in mobile systems, the excess fuel is generally not utilized efficiently, which is undesirable from a ecological and economic point of view.

It is an object of the present invention to provide a fuel cell system which, when the fuel supplied is used efficiently, allows rapid changes in the electrical output power of the system even if the flow of fuel supplied can only be changed slowly.

The object is achieved by a fuel cell system having the features of claim 1.

A system of this type allows a fuel cell to be operated with an electrical output power below a rated power of the cell for continuous operation by the fuel cell being operated intermittently in order to supply an electrical consumer with a low power, and in an operating phase in which the switch is closed, the fuel cell both supplies the consumer and charges the intermediate accumulator, whereas in an operating phase in which the switch is opened, the intermediate accumulator is responsible for supplying the electrical consumer.

Since the switch has to be able to switch under load, a semiconductor switch, in particular a MOSFET, is preferred.

The waste heat generated by a switch of this type can be used to good effect to heat the fuel cell if the latter is thermally coupled to the switch. In particular in the case of a fuel cell system having a stack of fuel cells, the switch is preferably arranged at one end of the stack, in order in this way to keep cells warm at the end of the stack, the temperature of which would otherwise drop undesirably compared to middle cells. Since the power loss which occurs at the switch in operation is greater than the heating power required to hold the stack at a desired operating temperature, a dedicated heating device for the fuel cell stack can be dispensed with.

The control circuit can control the opening and closing of the switch in each case on the basis of recorded values for a single operating parameter, or it can use one operating parameter to control the opening and a second operating parameter, which may be recorded by a different sensor, to control the closing.

The control circuit may be designed to continuously monitor the operating parameter(s) and to open the switch in each instance in response a first limit value being exceeded and to close the switch in response to a second limit value being intersected (by the same or a different operating parameter as in the case of the first limit value). Such a control strategy makes it possible for the available power to be precisely controlled to the power consumption of a consumer. In this case, the duration of an opening and closing cycle may be on the order of magnitude of a few seconds or more; the capacity of the intermediate accumulator must be dimensioned accordingly.

Another option is to include a pulse generator circuit in the control circuit which drives the switch with pulses whose pulse duty factor is variable as a function of the at least one operating parameter. This renders possible substantially shorter cycle times and/or operation of the switch with frequencies of up to 50 kHz. In this approach the required capacity of the intermediate accumulator is substantially lower, and voltage fluctuations at the consumer which result from the intermittent operation of the fuel cell, may be kept substantially smaller.

Suitable operating parameters to be monitored are in particular the terminal voltage of the fuel cell or, in the case of a stack of series-connected fuel cells, the terminal voltage or in particular the minimum cell voltage of all the cells of the overall stack, the internal resistance of an individual fuel cell or of a stack of fuel cells, or the hydrogen partial pressure of the cells. In this context, two different limit values for the same parameter can respectively be used as limit values for the opening and closing of the switch, or alternatively it is possible to use two limit values relating to different parameters. In particular if a cell voltage is used as criterion for opening of the switch, this voltage can be selected at such a low level that it allows CO oxidation in the cell(s). In particular if fuel cells are operated with reformer gas which may contain a CO content, this constituent, since it is not reacted under normal operating conditions, accumulates in the cells and leads to “poisoning” which manifests itself in an increase in the internal resistance of the cells and a drop in their terminal voltage, it being possible for the level of poisoning to differ for the individual cells of a stack.

The control circuit can also be used to control, in correlation with the control of the switch, the supply of fuel to the fuel cell or to a reformer which supplies the cell.

Further features and refinements of the invention will emerge from the following description of exemplary embodiments with reference to the appended figures, in which:

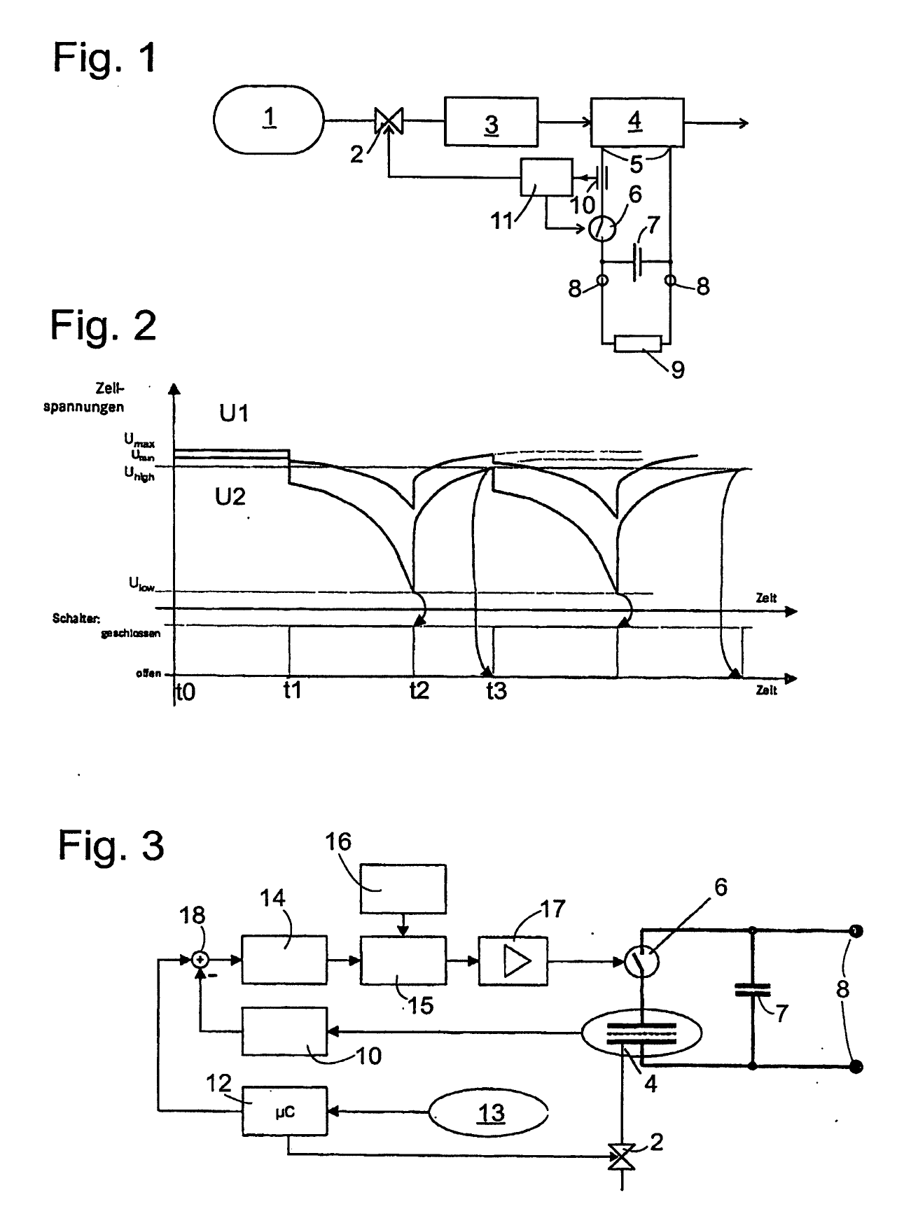

FIG. 1 shows a block diagram of a mobile fuel cell system according to the invention;

FIG. 2 shows the time curve of terminal voltages of fuel cells of the system according to the invention; and

FIG. 3 shows a block diagram of a fuel cell system in accordance with a second embodiment of the invention.

The fuel cell system shown in FIG. 1 comprises a tank 1 for a liquid fuel, such as for example gasoline, methanol or the like, which is connected to a reformer 3 via a regulating valve 2. The reformer 3 is used to convert the fuel into a gas mixture which contains, inter alia, molecular hydrogen. This gas mixture is fed to a fuel cell stack 4 which is connected to the reformer 3 and comprises a plurality of fuel cells electrically connected in series. The fuel cell stack 4 has electrical output connection terminals 5, between which a voltage resulting from the reaction of the hydrogen with oxygen to form water in the cells is present. A semiconductor device, in particular a MOSFET 6, and an intermediate electrical accumulator 7, in this case a secondary battery, are connected in series to the output connection terminals 5, so that when the switch 6 is closed the intermediate accumulator 7 can be charged with current from the fuel cell stack 4. The poles of the intermediate accumulator 7 simultaneously form the load connection terminals 8 of the fuel cell system, to which, as shown in the figure, an electrical consumer 9 is connected. When the switch 6 is closed, this consumer 9 likewise draws current from the fuel cell stack 4, whereas when the switch 6 is open it is supplied by the intermediate accumulator 7.

A sensor 10 for recording an operating parameter of the fuel cell stack is connected to a control circuit 11. The sensor 10 may be a measuring circuit for recording an output voltage or an internal resistance of the fuel cell stack 4; it is also possible to provide a plurality of measuring circuits of this type in order for the output voltage and internal resistance in each case to be recorded separately for the individual cells of the stack 4. Chemical sensors, in particular for recording a hydrogen partial pressure in the cells of the stack, may also be considered. The monitoring of one or more of these parameters—it is also possible to provide a plurality of sensors in combination—allows the control circuit 11 to assess the power performance of fuel cell stack 4, more specifically the ratio between fuel supply and electrical power tapped off by the consumer 9.

First of all, by way of example, consideration will be given to the situation in which there are sensors 10 for in each case measuring terminal voltages of individual cells of the stack 4. When the switch 6 is closed and the fuel cells are load-free, as in the time interval t0 to t1 in FIG. 2, the output power supplied is zero and the measured voltages have a constant, high value which may differ slightly from cell to cell. The curves denoted by Umax and Umin in FIG. 2 respectively show the highest and lowest voltage of all the cells of the stack 4. When the switch 6 is closed at instant t1, the curves Umax, Umin initially drop to a load value. The electrical output power delivered by the stack 4 at this instant is higher than what corresponds to the supply of primary power via the regulating valve 2. Therefore, the electrochemical conditions in the cells are not steady and the output voltages gradually decrease. If the control circuit 11, at instant t2, records that the output voltage Umin has reached a lower limit value Ulow, it opens the switch 6, so that current is no longer flowing and the voltages Umax, Umin initially rise abruptly. This is followed by a phase of a gradual rise, reflecting the fact that no electrical power is being drawn from the stack 4 but fuel is simultaneously flowing in, replacing the fuel which has previously been consumed excessively with the switch open. As soon as the voltage Umin reaches an upper limit value Uhigh (instant t3), the control circuit 11 opens the switch 6 again and the cycle repeats itself. Unlike the voltage Umin, the voltage at the load connection terminals 8 only oscillates within narrow limits, since it is buffered by the intermediate accumulator 7.

In principle, with the structure shown in FIG. 1 it is possible to regulate the electrical output power of the stack 4 by simply setting a gas flow rate at the regulating valve 2. As will readily be apparent, if the resistance of the consumer 9 is assumed to be constant, the lower the fuel feed rate, the shorter the phases in which the switch 6 is closed become and the longer the phases in which the switch is open. When the switch is closed, the electrical power which is tapped off is greater than the power supplied in the form of fuel; therefore, the cell is overloaded and its output voltage drops. While the switch is open, the consumer 9 is supplied from the intermediate accumulator 7 and the cell recovers. The interplay between the switch 6 and the intermediate accumulator 7 makes it possible to realize changes in the electrical output power of the fuel cell stack 4 at a higher speed than the speed with which the flow of fuel supplied by the reformer 3 can be matched to an altered power consumption by the consumer 9.

An option which is even more technically beneficial than that of regulating the electrical power of the fuel cell system by means of the supply of fuel is that of, conversely, allowing the control circuit 11 to regulate the fuel feed rate at the regulating valve 2 on the basis of the power required by the consumer 9. Brief fluctuations in the power demand of the consumer 9, as may occur in particular in mobile applications, can initially be absorbed by the intermediate accumulator 7. If an increased power demand is imposed for longer than what corresponds to the storage capacity of the intermediate accumulator 7, the fuel supply has to be readjusted. The control circuit 11 is able to estimate the power demand on the basis of the switching times t1, t2, t3, etc. The higher the power demand, the shorter the period of time [t1, t2] from closing of the switch until the voltage Umin reaches the lower limit value Ulow. By contrast, the duration of the subsequent recovery phase [t2, t3] is substantially dependent on the fuel feed rate. Therefore, the control circuit 11 keeps the ratio between these two time periods constant by, when it establishes that the time interval [t1, t2] has become shorter, actuating the control valve 2 in order to increase its throughput and, conversely, reducing its throughput when the period of time [t1, t2] becomes too long.

As has already been mentioned above, a CO content in the gas mixture delivered by the reformer can lead to poisoning of the cells of the stack 4, with the result that the internal resistance thereof increases, and their power delivery decreases. Carbon monoxide which has accumulated in a fuel cell in this way can be broken down by a temporary high electrical load forcing its output voltage below a limit value beyond which combustion of the CO commences in the cell. The lower voltage limit value Ulow can be selected to be below this limit value, so that in a load phase, in each case shortly before the switch 6 closes in the cell which supplies the voltage Umin and which will generally be the cell which is most strongly poisoned with CO, CO is broken down. If this breakdown phase is long enough to substantially completely breakdown the carbon monoxide in the cell, the performance of the cell is restored in the subsequent cycle, so that a different cell of the stack then delivers the lowest output voltage Umin. If the duration of the breakdown phase in insufficient to completely breakdown the CO, it nevertheless prevents a further drop in the performance of the cell and allows the stack 4 to continue to operate until the quantity of CO which has collected in all its cells is such that it is necessary to regenerate the entire stack.

If the CO poisoning is of only minor importance, operation below low cell voltages which allow the CO to be broken down in is not necessary or is only necessary from time to time. In this case, it may be desirable to increase the switching frequency of the switch 6 in order to reduce fluctuations in the voltage at the load connection terminals 8 and/or to reduce the quantity of energy which is to be stored in the intermediate accumulator 7 and thereby to allow a smaller, more lightweight and less expensive intermediate accumulator to be used.

A fuel cell system in accordance with a second configuration of the invention which satisfies these requirements is shown in FIG. 3. This configuration likewise comprises a fuel cell stack 4 and a switch 6, which are connected in series between two load connection terminals 8, and an intermediate accumulator 7 which is arranged in parallel with the fuel cell stack 4 and the switch 6. Just as has been described with reference to FIG. 1, one or more sensors 10 are arranged at the fuel cell stack 4. Depending on an operating strategy which is embodied in a control program 13, a microcontroller 12 delivers desired values for the operating parameters recorded by the sensor(s) 10. A subtraction element 18 or an operational amplifier determines a difference between operating parameter measured and desired values and feeds them to a regulator 14 which transforms them into a modulation signal for a PWM pulse generator 15. The latter supplies a pulse signal with a clock cycle which is predetermined by a clock generator 16 and a duty factor which is predetermined by the modulation signal to a driver 17 which holds the MOSFET switch 6 open or closed depending on the level of the control signal received from the modulator 15. The frequency of the pulse-width-modulated signal may be between 0.1 and 50 kHz, with the voltage ripple at the load connection terminals 8 being lower and the required storage capacity of the intermediate accumulator 7 being smaller, the higher this frequency is.

Since in the configuration shown in FIG. 3, the drop in the cell voltage under load, as shown in FIG. 2, cannot be observed, the power taken up by a consumer connected to the load connection terminals 8 has to be taken into account in the regulating strategy 13. This can be done, for example, with the aid of sensors (not shown) connected to the load connection terminals 8 for recording the current intensity or electric power flowing across them or by a control signal being fed to the microcontroller 12, which control signal is in the same way also fed to the consumer, in order to control the power of the latter, and is consequently representative of the power which the consumer takes up.

In this configuration too, the microcontroller 12 expediently also controls the fuel throughput through a regulating valve 2, which controls either the direct flow of hydrogen to the fuel cell stack 4 or the flow of fuel to a reformer connected upstream of the stack 4.

In both configurations, the switch 6 is in each case arranged at an end side of the fuel cell stack 4, in order for its waste heat to additionally heat the end-side fuel cells, which otherwise, when using heating of equal power for all the fuel cells, would be lower than that of the cells located in the middle of the stack. In this way, the switch 6 is held at a temperature in the range from 70 to 95° C., which standard semiconductors are well able to withstand. Since its waste heat is used to control the temperature of the fuel cells, the deterioration in the overall efficiency of the system according to the invention only amounts to the extent to which the power loss of the switch 6 exceeds the heating power which is in any case required to control the temperature of the fuel cells.

1-18. (canceled)

19. A fuel cell system comprising:
a fuel cell;
an intermediate electrical accumulator;
a common supply connector for coupling the fuel cell and intermediate electrical accumulator to an electrical consumer;
a sensor for sensing an operating parameter of the fuel cell;
a switch arranged and configured to be controlled to be in one of an open state and a closed state, the open state electrically isolating the fuel cell from the intermediate electrical accumulator and the common supply connector, and the closed state electrically coupling the fuel cell to the intermediate electrical accumulator and the common supply connector; and
a pulse generator control circuit for controlling the state of the switch between the open state and the closed state, by using pulses having a duty factor variable as a function of the recorded operating parameter.

20. The fuel cell system of claim 19, wherein the switch comprises a semiconductor switch.

21. The fuel cell system of claim 20, wherein the semiconductor switch comprises a MOSFET.

22. The fuel cell system of claim 19, wherein the switch is thermally coupled to the fuel cell.

23. The fuel cell system of claim 22, wherein the fuel comprises a stack of fuel cells and the switch is arranged at an end of the stack.

24. The fuel cell system of claim 19, wherein the pulse generator control circuit is arranged and configured to control the state of the switch between the open state and the closed state as a function of a single operating parameter.

25. The fuel cell system of claim 19, wherein the pulse generator control circuit is arranged and configured to control the state of the switch to be in the open state as a function of a first operating parameter and to control the state of the switch to be in the closed state as a function of a second operating parameter.

26. The fuel cell system of claim 19, wherein the pulses of the pulse generator control circuit have a frequency of between 0.1 and 50 kHz.

27. The fuel cell system of claim 19, wherein the sensor comprises a voltage sensor for recording a terminal voltage of the fuel cell.

28. The fuel cell system of claim 27, wherein the pulse generator control circuit is arranged and configured to control the state of the switch to be in the closed state when the voltage sensor senses an event of exceeding an upper limit voltage and to control the state of the switch to be in the open state when the voltage sensor senses an event of undershooting a lower limit voltage.

29. The fuel cell system of claim 19, wherein the sensor comprises an internal resistance sensor for recording an internal resistance of the fuel cell.

30. The fuel cell system of claim 29, wherein the pulse generator control circuit is arranged and configured to control the state of the switch to be in the closed state when the voltage sensor senses an event of exceeding an upper limit resistance and to control the state of the switch to be in the open state when the voltage sensor senses an event of undershooting a lower limit resistance.

31. The fuel cell system of claim 19, wherein the sensor comprises a pressure sensor for recording a hydrogen partial pressure of the fuel cell.

32. The fuel cell system of claim 31, wherein the pulse generator control circuit is arranged and configured to control the state of the switch to be in the closed state when the voltage sensor senses an event of exceeding an upper limit pressure and to control the state of the switch to be in the open state when the voltage sensor senses an event of undershooting a lower limit pressure.

33. The fuel cell system of claim 19, wherein the pulse generator control circuit is arranged and configured to control an operation gas feed line valve as a function of the recorded operating parameter.

34. The fuel cell system of claim 19, wherein the fuel cell is coupled to hydrogen source reformer.

35. The fuel cell system of claim 34, wherein the pulse generator control circuit is arranged and configured to control a throughput of the reformer as a function of the recorded operating parameter.
